(19) United States
(12) Patent Application Publication
(10) Pub. No.: US 2017/0061440 A1
(43) Pub. Date: Mar. 2, 2017

(54) Periodic Fraud Checks

(71) Applicant: Bank of America Corporation, Charlotte, NC (US)

(72) Inventor: William B. Belchee, Charlotte, NC (US)

(21) Appl. No.: 14/839,134

(22) Filed: Aug. 28, 2015

(51) Int. Cl. G06Q 20/40; G06Q 20/04

(52) U.S. Cl. CPC G06Q 20/4037; G06Q 20/4016; G06Q 20/042

(57) ABSTRACT

According to one embodiment, a system includes a memory comprising instructions; an interface; and a processor communicatively coupled to the memory and the interface. The interface is configured to receive an indication of a trigger event associated with a user account. The processor is configured, when executing the instructions, to select one or more transactions of a plurality of transactions associated with the user account, determine, for each of the selected transactions using one or more rules, whether the transaction is potentially fraudulent, and generate, for each transaction identified as potentially fraudulent, a notification comprising an identification of the transaction.

### TECHNICAL FIELD

This disclosure relates generally to online account security, and more particularly to performing periodic checks for fraudulent activity on user accounts.

### BACKGROUND

Online accounts may comprise sensitive information, such as confidential information, or allow access to financial accounts. Accordingly, there is a likelihood that the information or money in the accounts may be stolen or otherwise compromised. Current methods of monitoring for fraudulent activity focus on real-time monitoring, and notifying a user only of situations that have very high likelihood of being fraudulent.

### SUMMARY OF THE DISCLOSURE

In accordance with the present disclosure, disadvantages and problems associated with fraud monitoring may be reduced or eliminated.

According to one embodiment, a system is provided that includes a memory comprising instructions; an interface; and a processor communicatively coupled to the memory and the interface. The interface is configured to receive an indication of a trigger event associated with a user account. The processor is configured, when executing the instructions, to select one or more transactions of a plurality of transactions associated with the user account, determine, for each of the selected transactions using one or more rules, whether the transaction is potentially fraudulent, and generate, for each transaction identified as potentially fraudulent, a notification comprising an identification of the transaction.

According to one embodiment, a method is provided that comprises the steps of receiving an indication of a trigger event associated with a user account, selecting one or more transactions of a plurality of transactions associated with the user account, determining, for each of the selected transactions using one or more rules, whether the transaction is potentially fraudulent, and generating, for each transaction identified as potentially fraudulent, a notification comprising an identification of the transaction.

According to one embodiment, a computer-readable medium comprising instructions is provided. The instructions are configured when executed to receive an indication of a trigger event associated with a user account, select one or more transactions of a plurality of transactions associated with the user account, determine, for each of the selected transactions using one or more rules, whether the transaction is potentially fraudulent, and generate, for each transaction identified as potentially fraudulent, a notification comprising an identification of the transaction.

Technical advantages of certain embodiments of the present disclosure include periodically providing indications of potentially fraudulent activity, which may require fewer computer resources when compared to real-time fraud monitoring, and prompting users as to whether transactions are fraudulent, which may also require fewer computing resources when compared with making such determinations using the computing resources.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system comprising user devices accessing a server over a network;

FIG. 2 illustrates an example computer system in accordance with embodiments of the present disclosure;

FIGS. 3A-3C illustrates an example system performing a check for fraudulent activity on a user account in accordance with embodiments of the present disclosure; and

FIG. 4 illustrates an example method for performing periodic checks for fraudulent activity on user accounts in accordance with embodiments of the present disclosure.

### DETAILED DESCRIPTION

The present disclosure describes systems and methods for performing periodic checks for fraudulent activity on user accounts. For example, in some embodiments, after a pre-determined amount of time, a fraud analysis is performed on an account. The pre-determined amount of time may be a day, a week, a month, or any suitable amount of time. In other embodiments, the fraud analysis may be performed after a trigger event has happened, such as a sign-on or sign-off event. The fraud analysis may focus on a selected number of transactions (e.g., any new transactions since the last analysis was performed), in particular embodiments. The transactions may be interactions with the account (e.g., performing certain account functions such as logging in from a new geographic location or changing a password) or financial transactions (e.g., debit card or credit card purchases). After the fraud analysis has been run, a status indication may be shown to the account owner indicating whether there are any potentially fraudulent transactions of which she should be aware. For example, a notification message (e.g., short message service (SMS) messages or electronic mail messages) may be sent to a user device associated with the account owner. As another example, a pop-up message may be shown to the account owner on the user device associated with the account owner (e.g., after logging into or out of the account).

In one embodiment, for instance, a server receives an indication of a trigger event associated with a user account (e.g., a sign-on event or an expiration of a time period, such as a day or week) and in response, the server selects transactions of a plurality of transactions associated with the account for analysis. The server then determines whether the identified transactions are potentially fraudulent using one or more rules. The rules may be any pre-determined set of rules for determining whether transactions are potentially fraudulent. For particular transactions that are identified as potentially fraudulent, the server then generates a notification to the user comprising an indication of the particular transactions along with a reason for the transactions being identified as potentially fraudulent. Accordingly, aspects of the present disclosure may allow for proactive periodic monitoring of online account usage.

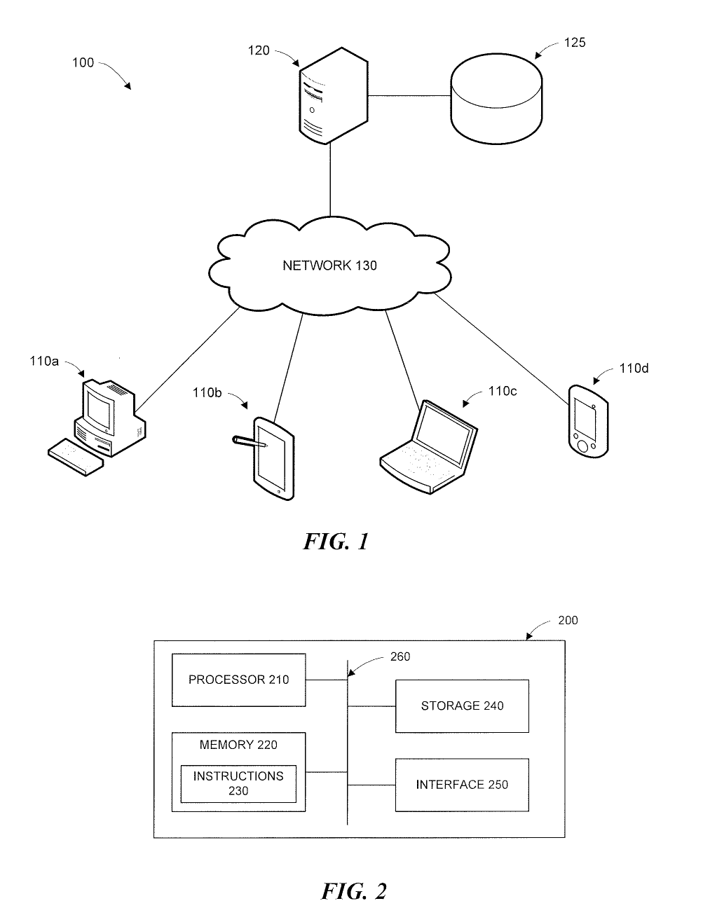

To facilitate a better understanding of the present disclosure, the following examples of certain embodiments are given. In no way should the following examples be read to limit, or define, the scope of the disclosure. Embodiments of the present disclosure and its advantages may be best understood by referring to FIGS. 1-4, where like numbers are used to indicate like and corresponding parts.

FIG. 1 illustrates an example system 100 comprising user devices 110 accessing server 120 over network 130 in accordance with embodiments of the present disclosure. User devices 110 may include any suitable computing device that may be used to access one or more functions of server 120 through network 130. User devices 110 may include mobile computing devices with wireless network connection capabilities (e.g., wireless-fidelity (WI-FI), and/or BLUETOOTH capabilities). For example, user devices 120 may include laptop computers, smartphones, or tablet computers (such as tablet 110b, laptop 110c, and smartphone 110). User devices 110 may also include non-mobile devices such as desktop computers (such as desktop 110a). In certain embodiments, a number of different user devices 110 may be associated with a particular user. For example, a particular user may own each of desktop computer 110a, tablet 110b, laptop 110c, and smartphone 110d, and may use such devices to access the one or more functions of server 120 as described herein.

Server 120 may provide one or more functions accessible to user devices 110, as described herein. For example, server 120 may provide users of user devices 110 access to one or more online accounts or account functions through a website, through a dedicated application installed on the user device 110, or through any other suitable means. In providing functionality to user devices 110, server 120 may access or otherwise utilize database 125.

Network 130 may include any suitable technique for communicably coupling user devices 110 with server 120. For example, network 130 may include an ad-hoc network, an intranet, an extranet, a virtual private network (VPN), a wired or wireless local area network (LAN), wide area network (WAN), metropolitan area network (MAN), a portion of the Internet, a portion of the Public Switched Telephone Network (PSTN), a portion of a cellular telephone network, or any combination thereof.

Modifications, additions, or omissions may be made to FIG. 1 without departing from the scope of the present disclosure. For example, FIG. 1 illustrates particular types of user devices 110. However, it will be understood that any suitable type of user device 110 may be used to access the one or more functions provided by server 120. As another example, although illustrated as a single server, server 120 may include a plurality of servers in certain embodiments. Similarly, although illustrated as a single database, database 125 may include a plurality of databases in some embodiments.

FIG. 2 illustrates an example computer system 200 in accordance with embodiments of the present disclosure. One or more aspects of computer system 200 may be used in user devices 110 or server 120 of FIG. 1. For example, each of user devices 110 or server 120 may include a computer system 200 in some embodiments. As another example, each of user devices 110 or server 120 may include two or more computer systems 200 in some embodiments.

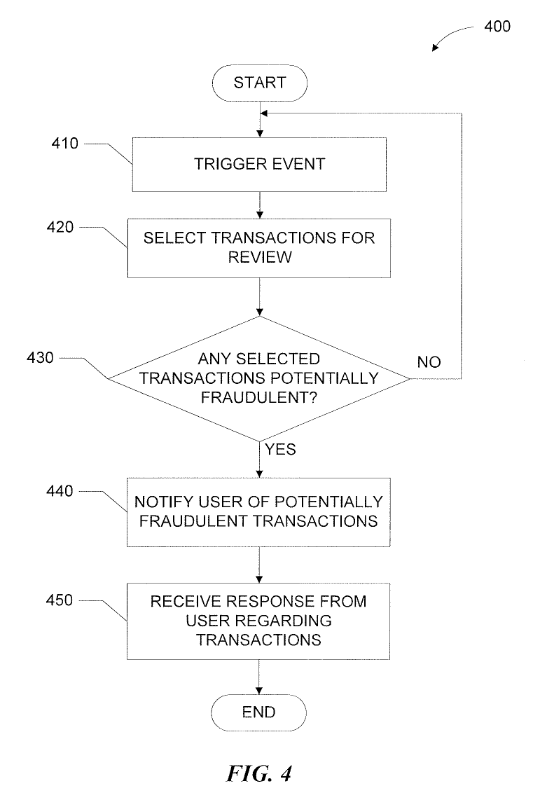

Computer system 200 may include a processor 210, memory 220 comprising instructions 230, storage 240, interface 250, and bus 260. These components may work together to perform one or more steps of one or more methods (e.g. method 400 of FIG. 4) and provide the functionality described herein. For example, in particular embodiments, instructions 230 in memory 220 may be executed on processor 210 in order to process requests received by interface 250 using common function modules. In certain embodiments, instructions 230 may reside in storage 240 instead of, or in addition to, memory 220.

Processor 210 may be a microprocessor, controller, application specific integrated circuit (ASIC), or any other suitable device or logic operable to provide, either alone or in conjunction with other components (e.g., memory 220 and instructions 230) functionality according to the present disclosure. Such functionality may include processing application functions using remotely-located common function modules, as discussed herein. In particular embodiments, processor 210 may include hardware for executing instructions 230, such as those making up a computer program or application. As an example and not by way of limitation, to execute instructions 230, processor 210 may retrieve (or fetch) instructions 230 from an internal register, an internal cache, memory 220, or storage 240; decode and execute them; and then write one or more results of the execution to an internal register, an internal cache, memory 220, or storage 240.

Memory 220 may be any form of volatile or non-volatile memory including, without limitation, magnetic media, optical media, random access memory (RAM), read-only memory (ROM), flash memory, removable media, or any other suitable local or remote memory component or components. Memory 220 may store any suitable data or information utilized by computer system 200, including software (e.g., instructions 230) embedded in a computer readable medium, and/or encoded logic incorporated in hardware or otherwise stored (e.g., firmware). In particular embodiments, memory 220 may include main memory for storing instructions 230 for processor 210 to execute or data for processor 210 to operate on. In particular embodiments, one or more memory management units (MMUs) may reside between processor 210 and memory 220 and facilitate accesses to memory 220 requested by processor 210.

Storage 240 may include mass storage for data or instructions (e.g., instructions 230). As an example and not by way of limitation, storage 240 may include a hard disk drive (HDD), a floppy disk drive, flash memory, an optical disc, a magneto-optical disc, magnetic tape, a Universal Serial Bus (USB) drive, a combination of two or more of these, or any suitable computer readable medium. Storage 240 may include removable or non-removable (or fixed) media, where appropriate. Storage 240 may be internal or external to computer system 200, where appropriate. In some embodiments, instructions 230 may be encoded in storage 240 in addition to, in lieu of, memory 220.

Interface 250 may include hardware, encoded software, or both providing one or more interfaces for communication (such as, for example, packet-based communication) between computer systems on a network (e.g., between employee devices 110 and back-end 130 of FIG. 1). As an example, and not by way of limitation, interface 250 may include a network interface controller (NIC) or network adapter for communicating with an Ethernet or other wire-based network and/or a wireless NIC (WNIC) or wireless adapter for communicating with a wireless network. Interface 250 may include one or more connectors for communicating traffic (e.g., IP packets) via a bridge card. Depending on the embodiment, interface 250 may be any type of interface suitable for any type of network in which computer system 200 is used. In some embodiments, interface 250 may include one or more interfaces for one or more I/O devices. One or more of these I/O devices may enable communication between a person and computer system 200. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these.

Bus 260 may include any combination of hardware, software embedded in a computer readable medium, and/or encoded logic incorporated in hardware or otherwise stored (e.g., firmware) to communicably couple components of computer system 200 to each other. As an example and not by way of limitation, bus 260 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 260 may include any number, type, and/or configuration of buses 260, where appropriate. In particular embodiments, one or more buses 260 (which may each include an address bus and a data bus) may couple processor 210 to memory 220. Bus 260 may include one or more memory buses.

Modifications, additions, or omissions may be made to FIG. 2 without departing from the scope of the present disclosure. For example, FIG. 2 illustrates components of computer system 200 in a particular configuration. However, any configuration of processor 210, memory 220, instructions 230, storage 240, interface 250, and bus 260 may be used, including the use of multiple processors 210 and/or buses 260. In addition, computer system 200 may be physical or virtual.

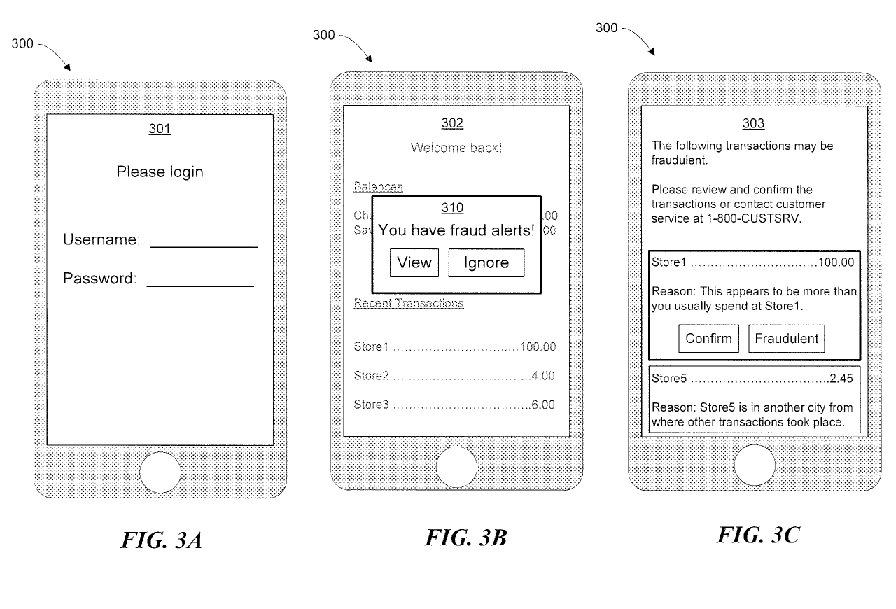

FIGS. 3A-3C illustrates an example system 300 performing a check for fraudulent activity on a user account in accordance with embodiments of the present disclosure. System 300 may include a user device connected to a server through a network (e.g., user device 110d of FIG. 1 connected to server 120 through network 130). Furthermore, system 300 may comprise one or more computing devices (e.g., computing device 200 of FIG. 2) or aspects thereof.

FIG. 3A illustrates a login screen 301 displayed on an interface of system 300. At the login screen, a user of system 300 may enter her credentials in order to gain access to one or more online accounts. Typically, after successfully entering credentials at login screen 301, the user is then presented with an account view 302 which displays one or more aspects of the user's account (e.g., balances or transactions of a financial account, as shown). However, in accordance with embodiments of the present disclosure, after successfully entering credentials at login screen 301 (i.e., a trigger event), a check for fraudulent activity notification 310 may be performed. The check may be performed on a selected group of transactions, such as those that are new since the last time the user logged into the account.

The fraudulent activity may be detected using one or more rules, which may be any suitable rules for detecting whether a particular transaction is potentially fraudulent. For instance, if a transaction does not match particular patterns of usage for the user for similar transactions (higher spending than usual at a certain store or transactions that occur in different cities on the same date, as shown in screen 303 of FIG. 3C), then the transaction may be marked as potentially fraudulent and a notification 310 may be generated and/or shown to the user as shown in FIG. 3B. Through the notification 310, the user may be prompted as to whether they wish to review the identified transactions. If so, the user may be presented with a list of the transactions identified as potentially fraudulent along with the reasons that such transactions were identified as being potentially fraudulent. The user may be further prompted, for each transaction, as to whether the transaction is fraudulent or not otherwise recognized or whether the transaction is confirmed as being performed by the user (or another authorized user of the account).

Modifications, additions, or omissions may be made to FIGS. 3A-3C without departing from the scope of the present disclosure. For example, FIGS. 3A-3C illustrate a particular type of system 300 performing a periodic check for fraudulent activity on a user account. However, it will be understood that any suitable type of user device 310 may be used to perform such a check for fraudulent activity. As another example, FIGS. 3A-3C illustrate a pop-up notification 310 indicating that transactions have been identified as potentially fraudulent. However, it will be understood that notification 310 may be another type of text-based message (e.g., an SMS or electronic mail message), a voice-based message, or any other suitable type of notification. Furthermore, although FIGS. 3A-3C illustrate the check for fraudulent activity as being performed after a user sign-on event, it will be understood that such checks may be performed in response to any suitable trigger event, such as a user sign-off event or after the expiration of a pre-determined period of time (e.g., a week after the last check or trigger event, such as if no intermediate trigger event has occurred).

FIG. 4 illustrates an example method 400 for performing periodic checks for fraudulent activity on user accounts in accordance with embodiments of the present disclosure. The method begins at step 410, where an indication of a trigger event associated with a user account is received. The indication may be received at a server that serves one or more functions of the account, such as server 120 of FIG. 1. The server may be a dedicated server for monitoring fraudulent activity, of may be an integrated server that performs additional functions with respect to the account. The indication may be based on trigger events such as a sign-on event, a sign-off event, or an expiration of a pre-determined period of time.

At step 420, particular transactions associated with the user account are selected for fraud review. The transactions may be selected using any suitable criteria. In certain embodiments, the selected transactions may include new transactions since the last trigger event. For example, the selected transactions may be the new transactions since the last sign-on event by the account owner. In some embodiments, the selected transactions may include all transactions over a certain period of time (e.g. a week or a month), regardless of when the last trigger event occurred.

At step 430, each of the selected transactions are reviewed to determine whether the transaction is potentially fraudulent. Fraudulent activity may be detected using one or more rules, which may be any suitable rules for detecting whether a particular transaction is potentially fraudulent. For instance, if a transaction does not match particular patterns of usage for the user for similar transactions (higher spending than usual at a certain store or transactions that occur in different cities on the same date, as shown in screen 303 of FIG. 3C), then the transaction may be identified as potentially fraudulent.

At step 450, a notification comprising an identification of the potentially fraudulent transactions is generated and sent to the account owner. The notification may be in any suitable form, and may include a text-based message or a voice-based message. For example, the notification may be an SMS message, electronic mail message, a pop-up notification, or a voice memo (e.g., a voicemail). In certain embodiments, the account owner may be prompted as to whether they wish to review the identified transactions. If so, the account owner may be presented with a list of the transactions identified as potentially fraudulent along with the reasons that such transactions were identified as being potentially fraudulent.

At step 460, feedback is received from user regarding the transactions. For example, the user may be prompted, for each transaction, as to whether the transaction is fraudulent or whether the transaction is confirmed as being performed by the user or an authorized user of the account. The user may thus use the reasons provided with each identified transaction to provide her feedback as to whether the transaction should be dealt with as fraudulent or not. Action may be taken with respect to the transactions marked as fraudulent by the user. For instance, a customer service representative associated with the account may be notified about the fraudulent transactions.

Modifications, additions, or omissions may be made to method 400 without departing from the scope of the present disclosure. For example, the order of the steps may be performed in a different manner than that described and some steps may be performed at the same time. Additionally, each individual step may include additional steps without departing from the scope of the present disclosure.

Although the present disclosure includes several embodiments, changes, substitutions, variations, alterations, transformations, and modifications may be suggested to one skilled in the art, and it is intended that the present disclosure encompass such changes, substitutions, variations, alterations, transformations, and modifications as fall within the spirit and scope of the appended claims.

What is claimed is:

1. A system comprising:
a memory comprising instructions;
an interface configured to receive an indication of a trigger event associated with a user account; and
a processor communicatively coupled to the memory and the interface, the processor configured, when executing the instructions, to:
select one or more transactions of a plurality of transactions associated with the user account;
determine, for each of the selected transactions using one or more rules, whether the transaction is potentially fraudulent; and
generate, for each transaction identified as potentially fraudulent, a notification comprising an identification of the transaction.

2. The system of claim 1, wherein the selected transactions comprise transactions occurring since a previous trigger event.

3. The system of claim 1, wherein the trigger event includes a sign-on event or a sign-off event.

4. The system of claim 1, wherein the trigger event includes an expiration of a timeout period.

5. The system of claim 1, wherein the notification further comprises a reason for the transaction being identified as potentially fraudulent.

6. The system of claim 1, wherein the notification comprises a text-based message.

7. The system of claim 1, wherein the interface is further configured to receive, in response to communicating the notification, an indication of an action to be taken with respect to the transaction identified in the notification.

8. A method, comprising:
receive an indication of a trigger event associated with a user account;
select one or more transactions of a plurality of transactions associated with the user account;
determine, for each of the selected transactions using one or more rules, whether the transaction is potentially fraudulent; and
generate, for each transaction identified as potentially fraudulent, a notification comprising an identification of the transaction.

9. The method of claim 8, wherein the selected transactions comprise transactions occurring since a previous trigger event.

10. The method of claim 8, wherein the trigger event includes a sign-on event or a sign-off event.

11. The method of claim 8, wherein the trigger event includes an expiration of a timeout period.

12. The method of claim 8, wherein the notification further comprises a reason for the transaction being identified as potentially fraudulent.

13. The method of claim 8, wherein the notification comprises a text-based message.

14. The method of claim 8, further comprising receiving, in response to communicating the notification, an indication of an action to be taken with respect to the transaction identified in the notification.

15. A computer-readable medium comprising instructions that are configured, when executed by a processor, to:
receive an indication of a trigger event associated with a user account;
select one or more transactions of a plurality of transactions associated with the user account;
determine, for each of the selected transactions using one or more rules, whether the transaction is potentially fraudulent; and
generate, for each transaction identified as potentially fraudulent, a notification comprising an identification of the transaction.

16. The computer-readable medium of claim 15, wherein the selected transactions comprise transactions occurring since a previous trigger event.

17. The computer-readable medium of claim 15, wherein the trigger event includes a sign-on event or a sign-off event.

18. The computer-readable medium of claim 15, wherein the trigger event includes an expiration of a timeout period.

19. The computer-readable medium of claim 15, wherein the notification further comprises a reason for the transaction being identified as potentially fraudulent.

20. The computer-readable medium of claim 15, wherein the notification comprises a text-based message.
